(19) United States
(12) Patent Application Publication
(10) Pub. No.: US 2026/0252334 A1
(43) Pub. Date: Aug. 27, 2026

(54) METHOD AND SYSTEM OF IMPLEMENTING EVENT CONSUMER APPLICATION DEPLOYMENT CONTROL WITHIN AN ELECTRONIC EVENT MESH

(71) Applicant: JPMorgan Chase Bank, N.A., New York, NY (US)

(72) Inventors: Michael MANIATIS, Libertyville, IL (US); Chris L LAUGHERY, Chicago, IL (US); Manuel CORDERO, Aurora, IL (US)

(73) Assignee: JPMorgan Chase Bank, N.A., New York, NY (US)

(21) Appl. No.: 19/445,262

(22) Filed: Jan. 9, 2026

Related U.S. Application Data
(60) Provisional application No. 63/763,651, filed on Feb. 26, 2025.

(51) Int. Cl. G06F 8/61

(52) U.S. Cl. CPC G06F 8/61

(57) ABSTRACT

A system is presented that provides event consumer application deployment control within at least one electronic event mesh. The system may be configured to: utilize representational state transfer (REST) application program interface (API) architecture to generate an event consumer application that comprises a first set of code that is based on the REST API architecture (REST API-based code); deploy the first set of REST API-based code to the at least one electronic event mesh; evaluate at least one performance of the first set of REST API-based code within the at least one electronic event mesh; and utilize the at least one performance of the first set of REST API-based code to determine whether to cancel or complete deployment of the event consumer application.

### CROSS-REFERENCE TO RELATED APPLICATIONS

This application claims priority benefit from provisional Application No. 63/763,651, filed on Feb. 26, 2025, which is hereby incorporated by reference in its entirety.

### BACKGROUND

### 1.Field

This disclosure generally relates to electronic event consumer applications and, more particularly, to a method, system, and computer-readable medium for implementing electronic event consumer application deployment control within at least one electronic event mesh.

### 2. Background

In electronics, an event refers to a detectable occurrence, or change to a state, in an electronic system. Conventional electronic systems typically utilize specialized software architecture paradigms to build networks that record, store and transmit such electronic events to one or more endpoint software applications that are configured to process (i.e., consume) such information.

However, in modern electronic event-driven systems, functionalities for controlling such event-driven endpoint software applications are rigid, inflexible and often nonexistent, which impedes efforts to keep event-driven endpoint software applications up to date.

Therefore, there is a need in the field of the present disclosure, for a technological improvement that addresses these drawbacks and provides simple and accessible techniques for controlling event-driven endpoint software applications.

Accordingly, the approach disclosed herein is presented to improve the field of the present disclosure by addressing the above-mentioned technical problems which exist in today’s electronic event-driven technologies.

### SUMMARY

The present disclosure, through one or more of its various aspects, embodiments, and/or specific features or sub-component, provides, inter alia, various systems, servers, devices, methods, media, programs and platforms for implementing event consumer application deployment control within at least one electronic event mesh.

According to an aspect of the invention, a method is provided that implements event consumer application deployment control within at least one electronic event mesh. The method may comprise: utilizing representational state transfer (REST) application program interface (API) architecture to generate an event consumer application that may comprise a first set of code that is based on the REST API architecture (REST API-based code); and deploying the first set of REST API-based code to the at least one electronic event mesh. The first set of REST API-based code may be configured to subscribe to a first set of event topics of the at least one electronic event mesh.

The method may further comprise: evaluating at least one performance of the first set of REST API-based code within the at least one electronic event mesh; and utilizing the at least one performance of the first set of REST API-based code to determine to one from among cancel deployment of the event consumer application and complete the deployment of the event consumer application.

In the method, the at least one electronic event mesh may comprise clusters and may utilize the clusters as primary sources, and primary sinks, of event flow traffic within the at least one electronic event mesh.

In the method, the at least one electronic event mesh may comprise a distributed, open-source, publish-subscribe messaging system.

In the method, when the at least one performance does not meet at least one predetermined criterion, then the at least one performance of the first set of REST API-based code is utilized to determine to cancel the deployment of the event consumer application and, alternatively, when the at least one performance meets the at least one predetermined criterion, then the at least one performance of the first set of REST API-based code is utilized to determine to complete the deployment of the event consumer application.

The method may further comprise cancelling the deployment of the event consumer application by utilizing REST API functionalities to recall the first set of REST API-based code from the at least one electronic event mesh.

In the method, the at least one electronic event mesh may comprise a pre-existing event consumer application that subscribes to at least one event topic to which the event consumer application is configured to subscribe.

The method may further comprise completing the deployment of the event consumer application, and the completing the deployment may comprise utilizing REST API functionalities to migrate, at least one event flow of the at least one electronic event mesh, onto the first set of REST API-based code, from the pre-existing event consumer application.

The method may further comprise consuming, by the first set of REST API-based code, the at least one event flow.

In the method, the completing the deployment may further comprise utilizing the REST API functionalities to recall the pre-existing event consumer application from the at least one electronic event mesh.

According to another aspect of the invention, a system is provided that implements event consumer application deployment control within at least one electronic event mesh. The system comprises a processor and memory which stores instructions that, when executed by the processor, may cause the processor to perform operations that comprise: utilizing REST API architecture to generate an event consumer application that may comprise a first set of REST API-based code; and deploying the first set of REST API-based code to the at least one electronic event mesh. The first set of REST API-based code may be configured to subscribe to a first set of event topics of the at least one electronic event mesh.

In the system, when executed, the instructions may cause the processor to perform further operations that comprise: evaluating at least one performance of the first set of REST API-based code within the at least one electronic event mesh; and utilizing the at least one performance of the first set of REST API-based code to determine to one from among cancel deployment of the event consumer application and complete the deployment of the event consumer application.

In the system, when executed by the processor, the instructions may cause the at least one electronic event mesh to comprise clusters and to utilize the clusters as primary sources, and primary sinks, of event flow traffic within the at least one electronic event mesh.

In the system, when executed by the processor, the instructions may cause the at least one electronic event mesh to comprise a distributed, open-source, publish-subscribe messaging system.

In the system, when the instructions are executed and the at least one performance does not meet at least one predetermined criterion, then the processor may utilize the at least one performance of the first set of REST API-based code to determine to cancel the deployment of the event consumer application and, alternatively, when the instructions are executed and the at least one performance meets the at least one predetermined criterion, then the processor may utilize the at least one performance of the first set of REST API-based code to determine to complete the deployment of the event consumer application.

In the system, when executed, the instructions may cause the processor to perform further operations that comprise cancelling the deployment of the event consumer application by utilizing REST API functionalities to recall the first set of REST API-based code from the at least one electronic event mesh.

In the system, when executed by the processor, the instructions may cause the at least one electronic event mesh to comprise a pre-existing event consumer application that subscribes to at least one event topic to which the event consumer application is configured to subscribe.

In the system, when executed, the instructions may cause the processor to perform further operations that comprise completing the deployment of the event consumer application, and the completing the deployment may comprise utilizing REST API functionalities to migrate, at least one event flow of the at least one electronic event mesh, onto the first set of REST API-based code, from the pre-existing event consumer application.

In the system, wherein when executed, the instructions may cause the processor to perform further operations that comprise consuming, by the first set of REST API-based code, the at least one event flow.

In the system, when executed by the processor, the instructions may cause the completing the deployment to further comprise utilizing the REST API functionalities to recall the pre-existing event consumer application from the at least one electronic event mesh.

According to yet another aspect of the invention, a non-transitory computer-readable medium is provided that implements event consumer application deployment control within at least one electronic event mesh. The computer-readable medium may store instructions that, when executed by a processor, cause the processor to perform operations that comprise: utilizing REST API architecture to generate an event consumer application that may comprise a first set of REST API-based code; and deploying the first set of REST API-based code to the at least one electronic event mesh. The first set of REST API-based code may be configured to subscribe to a first set of event topics of the at least one electronic event mesh.

In the computer-readable medium, when executed, the instructions may cause the processor to perform further operations that comprise: evaluating at least one performance of the first set of REST API-based code within the at least one electronic event mesh; and utilizing the at least one performance of the first set of REST API-based code to determine to one from among cancel deployment of the event consumer application and complete the deployment of the event consumer application.

In the computer-readable medium, when executed by the processor, the instructions may cause the at least one electronic event mesh to comprise clusters and may utilize the clusters as primary sources, and primary sinks, of event flow traffic within the at least one electronic event mesh.

In the computer-readable medium, when executed by the processor, the instructions may cause the at least one electronic event mesh to comprise a distributed, open-source, publish-subscribe messaging system.

In the computer-readable medium, when the instructions are executed and the at least one performance does not meet at least one predetermined criterion, then the processor may utilize the at least one performance of the first set of REST API-based code to determine to cancel the deployment of the event consumer application and, alternatively, when the instructions are executed and the at least one performance meets the at least one predetermined criterion, then the processor may utilize the at least one performance of the first set of REST API-based code to determine to complete the deployment of the event consumer application.

In the computer-readable medium, when executed, the instructions may cause the processor to perform further operations that comprise cancelling the deployment of the event consumer application by utilizing REST API functionalities to recall the first set of REST API-based code from the at least one electronic event mesh.

In the computer-readable medium, when executed by the processor, the instructions may cause the at least one electronic event mesh to comprise a pre-existing event consumer application that subscribes to at least one event topic to which the event consumer application is configured to subscribe.

In the computer-readable medium, when executed, the instructions may cause the processor to perform further operations that comprise completing the deployment of the event consumer application, and the completing the deployment may comprise utilizing REST API functionalities to migrate, at least one event flow of the at least one electronic event mesh, onto the first set of REST API-based code, from the pre-existing event consumer application.

In the computer-readable medium, when executed, the instructions may cause the processor to perform further operations that comprise consuming, by the first set of REST API-based code, the at least one event flow.

In the computer-readable medium, when executed by the processor, the instructions may cause the completing the deployment to comprise utilizing the REST API functionalities to recall the pre-existing event consumer application from the at least one electronic event mesh.

Accordingly, the invention disclosed herein provides event consumer application deployment control within at least one electronic event mesh.

### BRIEF DESCRIPTION OF THE DRAWINGS

The present disclosure is further described in the detailed description which follows, in reference to the noted plurality of drawings, by way of non-limiting examples of the present disclosure, in which like characters represent like elements throughout the several views of the drawings.

FIG. 1 depicts a diagram of computer system, according to an embodiment.

FIG. 2 depicts a diagram of an environment for implementing event consumer application deployment control, according to an embodiment.

FIG. 3 depicts a diagram of an aspect of an environment that is configured to implement event consumer application deployment control, according to an embodiment.

FIG. 4 depicts a flowchart of a process for implementing event consumer application deployment control, according to an embodiment.

FIG. 5 depicts a diagram of a perspective of an environment that implements an event consumer application deployment control configuration, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable code that, when executed by one or more processors, cause the processors to carry out operations necessary to implement the methods of the examples of this technology that are described and illustrated herein.

Accordingly, the herein-disclosed technology may provide a system that implements event consumer application deployment control within at least one electronic event mesh by executing operations (described in further detail below) that comprise utilizing representational state transfer (REST) application program interface (API) architecture to generate an event consumer application that comprises a first set of code that is based on the REST API architecture (REST API-based code); deploying the first set of REST API-based code to the at least one electronic event mesh; evaluating at least one performance of the first set of REST API-based code within the at least one electronic event mesh; and utilizing the at least one performance of the first set of REST API-based code to determine whether to cancel or complete deployment of the event consumer application.

Therefore, by employing the herein-disclosed approaches within at least one electronic event mesh, the disclosed subject matter provides a technical improvement to existing technology. Thereby, the approaches disclosed herein provide a solution to needs that exist in conventional AI/ML technologies, such as the need to provide simple and accessible techniques for controlling event-driven endpoint software applications and for keeping such applications up-to-date.

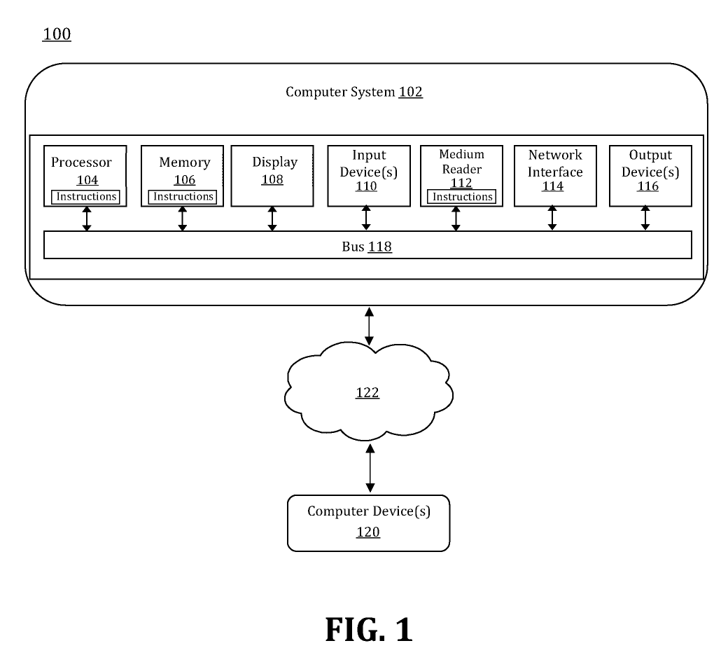

FIG. 1 is a system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for longer than a transitory period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely examples and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in a non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

Accordingly, the herein-disclosed technology may provide a system that implements event consumer application deployment control within at least one electronic event mesh by executing operations (described in further detail below) that comprise utilizing REST API architecture to generate an event consumer application that comprises a first set of REST API-based code; deploying the first set of REST API-based code to the at least one electronic event mesh; evaluating at least one performance of the first set of REST API-based code within the at least one electronic event mesh; and utilizing the at least one performance of the first set of REST API-based code to determine whether to cancel or complete deployment of the event consumer application.

Therefore, by employing the herein-disclosed approaches within at least one electronic event mesh, the disclosed subject matter provides a technical improvement to existing technology. Thereby, the approaches disclosed herein provide a solution to needs that exist in conventional AI/ML technologies, such as the need to provide simple and accessible techniques for controlling event-driven endpoint software applications and for keeping such applications up-to-date.

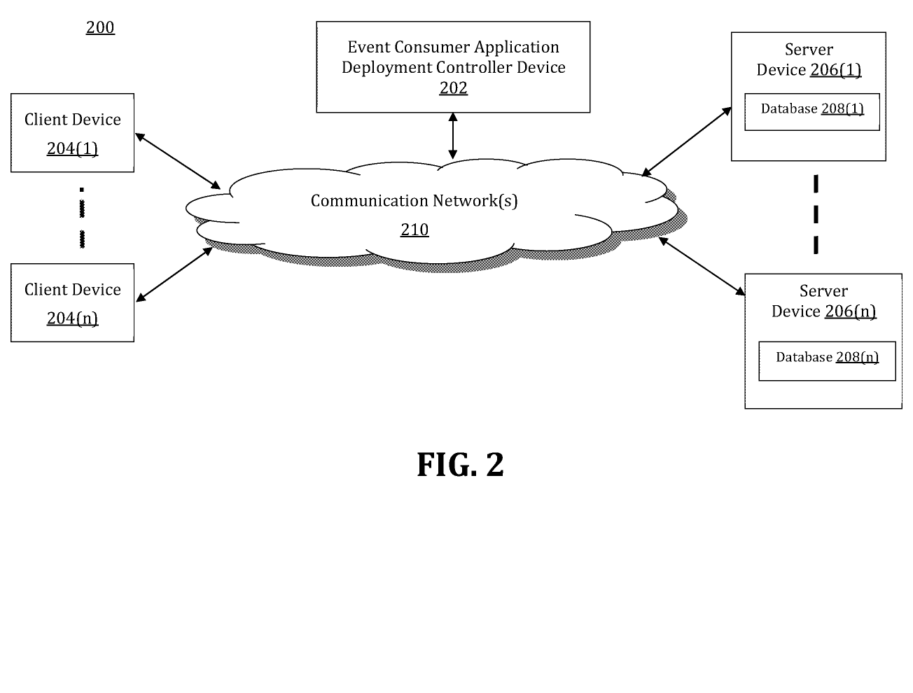

Referring to FIG. 2, a schematic of a network environment 200 for implementing an event consumer application deployment controller. In an embodiment, the event consumer application deployment controller may be implemented on any networked computer platform, such as, for example, a personal computer (PC).

A method for implementing event consumer application deployment control within at least one electronic event mesh, may be implemented by an event consumer application deployment controller (ECADC) device 202. The ECADC device 202 may be the same or similar to the computer system 102 as described with respect to FIG. 1. The ECADC device 202 may be a rack-mounted server in a datacenter, an embedded microcontroller (MCU) in an electronic device, or another type of headless system, which is a computer system or device that is configured to operate without a monitor, keyboard and mouse. The ECADC device 202 may store one or more applications that can include executable instructions that, when executed by the ECADC device 202, cause the ECADC device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ECADC device 202 itself, may be located in virtual server(s) running in a cloud-based computing environment rather than being tied to one or more specific physical network computing devices. Also, the application(s) may be running in one or more virtual machines (VMs) executing on the ECADC device 202. Additionally, in one or more embodiments of this technology, virtual machine(s) running on the ECADC device 202 may be managed or supervised by a hypervisor.

In the network environment 200 of FIG. 2, the ECADC device 202 is coupled to a plurality of client devices 204(1)-204(n), and also to a plurality of server devices 206(1)-206(n) that hosts a plurality of databases 208(1)-208(n) via communication network(s) 210. A communication interface of the ECADC device 202, such as the network interface 114 of the computer system 102 of FIG. 1, operatively couples and communicates between the ECADC device 202, the client devices 204(1)-204(n), and/or the server devices 206(1)-206(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ECADC device 202, the client devices 204(1)-204(n), and/or the server devices 206(1)-206(n) may be coupled together via other topologies. Additionally, the network environment 200 may include other network devices such as one or more routers and/or switches, for example, which are well known in the art and thus will not be described herein. This technology provides a number of advantages including methods, computer readable media, and ECADC devices that implement a method for an event consumer application deployment controller that implements event consumer application deployment control within at least one electronic event mesh.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. For the purposes of the present disclosure, it should be noted that: the term “remote” may refer to a “physical” and/or “virtual” remoteness; and the term “local” may refer to a “physical” and/or “virtual” locale.

The ECADC device 202 may be a standalone device or integrated with one or more other devices or apparatuses, such as one or more of the server devices 206(1)-206(n), for example. In one particular example, the ECADC device 202 may include or be hosted by one of the server devices 206(1)-206(n), and other arrangements are also possible. As another example, the ECADC device 202 may be integrated with one or more other devices or apparatuses, such as one or more of the client devices 204(1)-204(n). Moreover, one or more of the devices of the ECADC device 202 may be in a same or a different communication network including one or more public, private, or cloud networks, for example.

The plurality of server devices 206(1)-206(n) may be the same or similar to the computer system 102 or the computer device 120 as described with respect to FIG. 1, including any features or combination of features described with respect thereto. For example, any of the server devices 206(1)-206(n) may include, among other features, one or more processors, memories and communication interfaces, which are coupled together by at least one bus or other communication link, although other numbers and/or types of network devices may be used. The server devices 206(1)-206(n) in this example may process requests received from the ECADC device 202 via the communication network(s) 210 according to an HTTP-based and/or JavaScript Object Notation (JSON) protocol, for example, although other protocols may also be used.

The server devices 206(1)-206(n) may be hardware or software or may represent a system with multiple servers in a pool, which may include internal or external networks. The server devices 206(1)-206(n) hosts the databases 208(1)-208(n) that are configured to store data.

Although the server devices 206(1)-206(n) are illustrated as single devices, one or more actions of each of the server devices 206(1)-206(n) may be distributed across one or more distinct network computing devices that together comprise one or more of the server devices 206(1)-206(n). Moreover, the server devices 206(1)-206(n) are not limited to a particular configuration. Thus, the server devices 206(1)-206(n) may contain a plurality of network computing devices that operate using a master/slave approach, whereby one of the network computing devices of the server devices 206(1)-206(n) operates to manage and/or otherwise coordinate operations of the other network computing devices.

The server devices 206(1)-206(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures are also envisaged.

The plurality of client devices 204(1)-204(n) may also be the same or similar to the computer system 102 or the computer device 120 as described with respect to FIG. 1, including any features or combination of features described with respect thereto. For example, the client devices 204(1)-204(n) in this example may include any type of computing device that can interact with the ECADC device 202 via communication network(s) 210. Accordingly, the client devices 204(1)-204(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 204 is a wireless mobile communication device, i.e., a smart phone.

The client devices 204(1)-204(n) may run interface applications, such as standard web browsers or standalone client applications, which may provide an interface to communicate with the ECADC device 202 via the communication network(s) 210 in order to communicate user requests and other information. The client devices 204(1)-204(n) may further include, among other features, a display device, such as a display screen or touchscreen, and/or an input device, such as a keyboard, for example. The client devices 204(1)-204(n) may host one or more applications that are proprietary to an enterprise that may be secured against eavesdropping, and these applications may be distributed among client devices 204(1)-204(n). The enterprise’s distributed applications may include software that is based on microservices architecture, for example.

Although the network environment 200 with the ECADC device 202, the client devices 204(1)-204(n), the server devices 206(1)-206(n), the databases 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ECADC device 202, the client devices 204(1)-204(n), the server devices 206(1)-206(n), and the databases 208(1)-208(n), for example, may be configured to operate as virtual instances on the same physical machine. In other words, one or more of the ECADC device 202, the server devices 206(1)-206(n), the client devices 204(1)-204(n), and the databases 208(1)-208(n) may operate on a common physical device rather than as separate devices communicating through communication network(s) 210. Additionally, there may be more or fewer client devices 204(1)-204(n), server devices 206(1)-206(n), and databases 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

Accordingly, the herein-disclosed technology may provide a system that implements event consumer application deployment control within at least one electronic event mesh by executing operations (described in further detail below) that comprise utilizing REST API architecture to generate an event consumer application that comprises a first set of REST API-based code; deploying the first set of REST API-based code to the at least one electronic event mesh; evaluating at least one performance of the first set of REST API-based code within the at least one electronic event mesh; and utilizing the at least one performance of the first set of REST API-based code to determine whether to cancel or complete deployment of the event consumer application.

Therefore, by employing the herein-disclosed approaches within at least one electronic event mesh, the disclosed subject matter provides a technical improvement to existing technology. Thereby, the approaches disclosed herein provide a solution to needs that exist in conventional AI/ML technologies, such as the need to provide simple and accessible techniques for controlling event-driven endpoint software applications and for keeping such applications up-to-date.

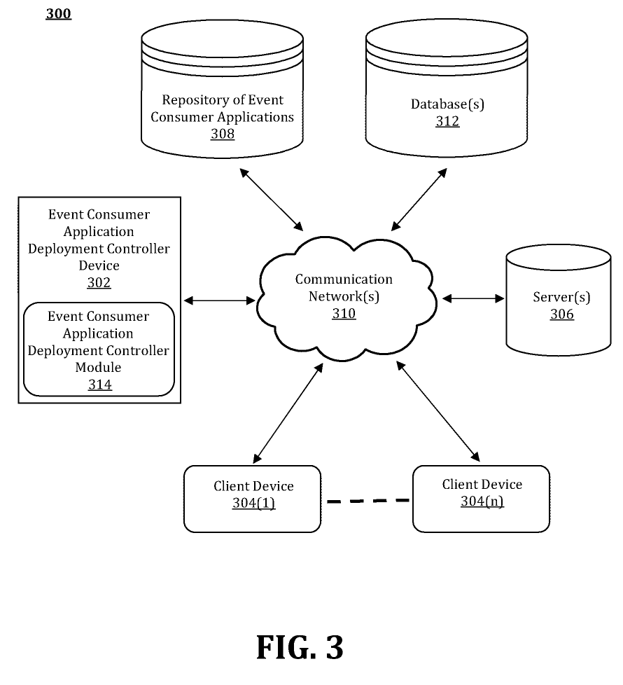

The ECADC device 302 is described and illustrated in FIG. 3 as including event consumer application deployment controller module 314, although it may include other rules, policies, modules, databases, or applications, for example. As will be described below, event consumer application deployment controller module 314 is configured to implement event consumer application deployment control within at least one electronic event mesh, such as communication network(s) 310, for example. Event consumer application deployment controller module 314 may include software that is based on microservices architecture, for example.

Event consumer application deployment controller module 314 may be integrated with one or more devices or apparatuses, such as client devices 304(1)-304(n), where event consumer application deployment controller module 314 may be implemented as an application or as an addon or plugin to another application of the one or more devices or apparatuses, and where event consumer application deployment controller module 314 may execute in the background.

A configuration 300 for applying event consumer application deployment control within an aspect of the network environment of FIG. 2 is illustrated as being executed in FIG. 3. Specifically, client devices 304(1)-304(n) are illustrated as being in communication with ECADC device 302. In this regard, a first client device 304(1) and at least a second client device 304(2) may be “clients” of the ECADC device 302 and are described herein as such. Nevertheless, it is to be known and understood that client device 304(1) and/or at least client device 304(2) need not necessarily be “clients” of the ECADC device 302, or any entity described in association therewith herein. Any additional or alternative relationship may exist between client device 304(1), client device 304(2) and ECADC device 302.

Event consumer application deployment controller module 314 of ECADC device 302 may communicate with at least one database and/or repository, such as repository of event consumer applications 308. Thereby, as described in further detail below, ECADC device 302 may utilize one or more local and/or network repositories to store at least one from among data, parameters, features, attributes, algorithms, software, datasets and/or other information for implementing event consumer application deployment control within at least one electronic event mesh.

In addition, event consumer application deployment controller module 314 of ECADC device 302 may communicate with database(s) 312. Thereby, as described in further detail below, ECADC device 302 may obtain data from one or more database(s) 312.

In an embodiment, event consumer application deployment controller module 314 may be configured to provide a dynamically customizable interface for selecting, to communicate with, at least one server device at least one from among server devices 306(1)-306(n). Moreover, ECADC device 302 may receive and transmit data via communication network(s) 210. ECADC device 302 may receive and transmit data such as code that is written in one or more of the following dialects: transaction control language (TCL), data manipulation language (DML), data control language (DCL) and data definition language (DDL). Additionally, via communication network(s) 310, ECADC device 302 may respectively receive and transmit data from and to one or more from among client devices 304(1)-304(n) and the server devices 306(1)-306(n).

However, FIG. 3 depicts client device 304(1) and at least client device 304(n) as belonging to communication network(s) 310, and ECADC device 302 may communicate with any one or more devices or apparatuses that belong to the communication network(s) 310, such as one or more from among client devices 304(1)-304(n). For example, ECADC device 302 may utilize a graphical user interface (GUI) to communicate with one or more from among client devices 304(1)-304(n), and communication network(s) 310 may comprise a cluster that belongs to the above-mentioned enterprise that may be secured against eavesdropping. In a further embodiment, communication network(s) 310 may comprise a cluster of distributed applications that belong to the enterprise.

Client device 304(1) may be, for example, a smart phone. Of course, client device 304(1) may be any additional device described herein. Client device 304(n) may be, for example, a personal computer (PC). Of course, client device 304(n) may also be any additional device described herein.

The client devices 304(1)-304(n) may represent, for example, computer systems of the enterprise’s client network. Client device 304(1) may represent, for example, one or more computer systems of a client or of a cluster of clients within the enterprise or client network. Of course, client device 304(1) may include one or more of any of the devices described herein. Client device 304(n) may be, for example, one or more computer systems of another client or cluster of clients within the enterprise or client network. Of course, client device 304(n) may include one or more of any of the devices described herein.

The herein-disclosed process(es) may be executed via the communication network(s) 310, which may comprise plural networks as described above. For example, in an embodiment, either or both of client device 304(1) and client device 204(n) may communicate with the ECADC device 302 via broadband or cellular communication. Of course, these embodiments are merely exemplary and are not limiting or exhaustive.

Event consumer application deployment controller module 314 may programmatically configure and communicate with client devices 304(1)-304(n), which may respectively correspond to one or more remote clusters of endpoints, for example.

Event consumer application deployment controller module 314 may execute a process that programmatically configures and communicates with one or more client devices from among client devices 304(1)-304(n). In some embodiments, at least one (and possibly each) from among server devices 306(1)-306(n) may utilize a database, such as database(s) 312, to provide event broker services within an electronic event mesh (see, e.g., server devices 206(1)-206(n)).

Accordingly, the herein-disclosed technology may provide a system that implements event consumer application deployment control within at least one electronic event mesh by executing operations (described in further detail below) that comprise utilizing REST API architecture to generate an event consumer application that comprises a first set of REST API-based code; deploying the first set of REST API-based code to the at least one electronic event mesh; evaluating at least one performance of the first set of REST API-based code within the at least one electronic event mesh; and utilizing the at least one performance of the first set of REST API-based code to determine whether to cancel or complete deployment of the event consumer application.

Therefore, by employing the herein-disclosed approaches within at least one electronic event mesh, the disclosed subject matter provides a technical improvement to existing technology. Thereby, the approaches disclosed herein provide a solution to needs that exist in conventional AI/ML technologies, such as the need to provide simple and accessible techniques for controlling event-driven endpoint software applications and for keeping such applications up-to-date.

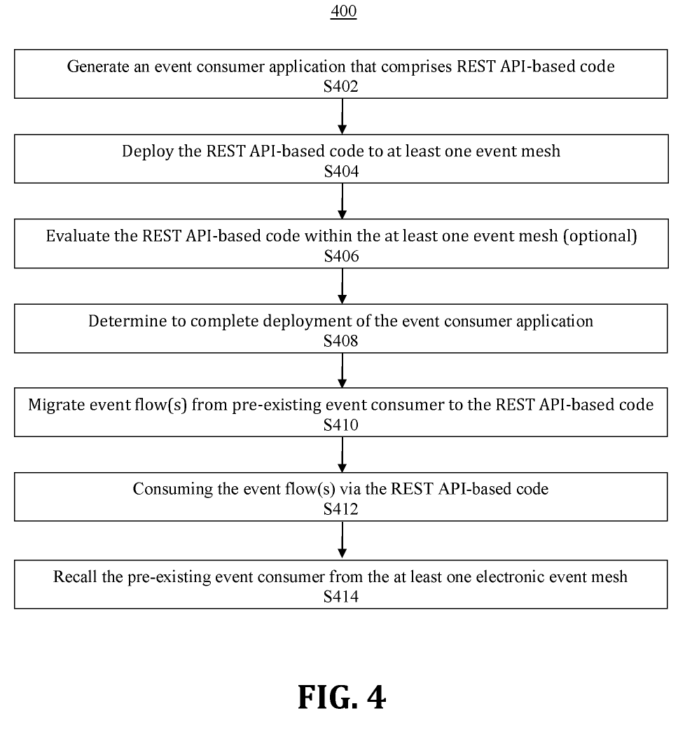

A process for an event consumer application deployment controller is generally indicated at flowchart 400 in FIG. 4. Process 400 may be performed to provide event consumer application deployment control within at least one electronic event mesh, which may comprise a distributed, open-source, publish-subscribe messaging system. Additionally, the at least one electronic event mesh may comprise clusters, which the at least one electronic event mesh may utilize as primary sources, and primary sinks, of its event flow traffic.

At step S402, the event consumer application deployment controller (such as event consumer application deployment controller 202, event consumer application deployment controller device 302 and/or event consumer application deployment controller module 314) may utilize representational state transfer (REST) application program interface (API) architecture to generate an event consumer application that comprises a first set of code that is based on the REST API architecture (REST API-based code). The first set of REST API-based code may be configured to subscribe to a first set of event topics of the at least one electronic event mesh.

At step S404, the event consumer application deployment controller may deploy the first set of REST API-based code to the at least one electronic event mesh. At step S404, the event consumer application deployment controller may deploy the first set of REST API-based code from at least one database and/or repository, such as repository of event consumer applications 308, for example.

Additionally, at step S404, the event consumer application deployment controller may deploy the first set of REST API-based code to at least one from among and existing event consumer client and a new event consumer client, which may be implemented within one or more client devices, such as client devices 304(1)-304(n), for example. Accordingly, the at least one electronic event mesh may comprise a pre-existing event consumer application that subscribes to at least one event topic to which the event consumer application is configured to subscribe.

Optionally, at step S406, the event consumer application deployment controller may evaluate at least one performance of the first set of REST API-based code within the at least one electronic event mesh. This evaluation of step S406 may comprise testing the least one performance of the first set of REST API-based code within the at least one electronic event mesh. In addition, step S406’s evaluation may comprise utilizing results of the test to determine the at least one performance of the first set of REST API-based code within the at least one electronic event mesh.

At step S408, the event consumer application deployment controller may determine whether to complete deployment of the event consumer application. Additionally, if the event consumer application deployment controller evaluates the at least one performance, at step S408, the event consumer application deployment controller may utilize the at least one performance of the first set of REST API-based code to determine to one from among: cancel deployment of the event consumer application and complete deployment of the event consumer application.

Accordingly, in process 400, if the event consumer application deployment controller evaluates the at least one performance, at step S408, the event consumer application deployment controller may utilize the at least one performance of the first set of REST API-based code to determine to cancel deployment of the event consumer application when the at least one performance does not meet at least one predetermined criterion and, alternatively, the event consumer application deployment controller may utilize the at least one performance of the first set of REST API-based code to determine to complete deployment of the event consumer application when the at least one performance meets the at least one predetermined criterion.

In the event that the event consumer application deployment controller determines to cancel deployment of the event consumer application, the event consumer application deployment controller may cancel deployment of the event consumer application by utilizing REST API functionalities to recall the first set of REST API-based code from the at least one electronic event mesh.

Alternatively, in process 400, if the event consumer application deployment controller determines to complete deployment of the event consumer application, at step S410, the event consumer application deployment controller may utilize REST API functionalities to migrate, at least one event flow of the at least one electronic event mesh, onto the first set of REST API-based code, from the pre-existing event consumer application.

Accordingly, in process 400, if the event consumer application deployment controller determines to complete deployment of the event consumer application, at step S410, the event consumer application deployment controller may utilize REST API functionalities to migrate, at least one event flow of the at least one electronic event mesh, onto the first set of REST API-based code, from the pre-existing event consumer application.

As indicated above, client devices such as client devices 304(1)-304(n) may correspond to one or more clusters of endpoints that are utilized—by the at least one electronic event mesh—as primary sources, and primary sinks, of the at least one electronic event mesh’s event flow traffic. Server devices such as server devices 206(1)-206(n) and/or server(s) 306 may correspond to at least one event broker of the at least one electronic event mesh and, although depicted as distinct elements of configuration 300, it should be noted that server(s) 306 may respectively comprise(s) database(s) 312. Moreover, server(s) 306 and database(s) 312 may work in conjunction to implement the at least one event broker.

Additionally, in process 400, if the event consumer application deployment controller determines to complete deployment of the event consumer application, at step S412, the event consumer application deployment controller may utilize REST API functionalities to configure the first set of REST API-based code to consume the at least one event flow of the at least one electronic event mesh, and the first set of REST API-based code may respond by consuming the at least one event flow.

At step S414, the event consumer application deployment controller may utilize the REST API functionalities to recall the pre-existing event consumer application from the at least one electronic event mesh.

Accordingly, the herein-disclosed technology may provide a system that implements event consumer application deployment control within at least one electronic event mesh by executing operations that comprise utilizing REST API architecture to generate an event consumer application that comprises a first set of REST API-based code; deploying the first set of REST API-based code to the at least one electronic event mesh; evaluating at least one performance of the first set of REST API-based code within the at least one electronic event mesh; and utilizing the at least one performance of the first set of REST API-based code to determine whether to cancel or complete deployment of the event consumer application.

Therefore, by employing the herein-disclosed approaches within at least one electronic event mesh, the disclosed subject matter provides a technical improvement to existing technology. Thereby, the approaches disclosed herein provide a solution to needs that exist in conventional AI/ML technologies, such as the need to provide simple and accessible techniques for controlling event-driven endpoint software applications and for keeping such applications up-to-date.

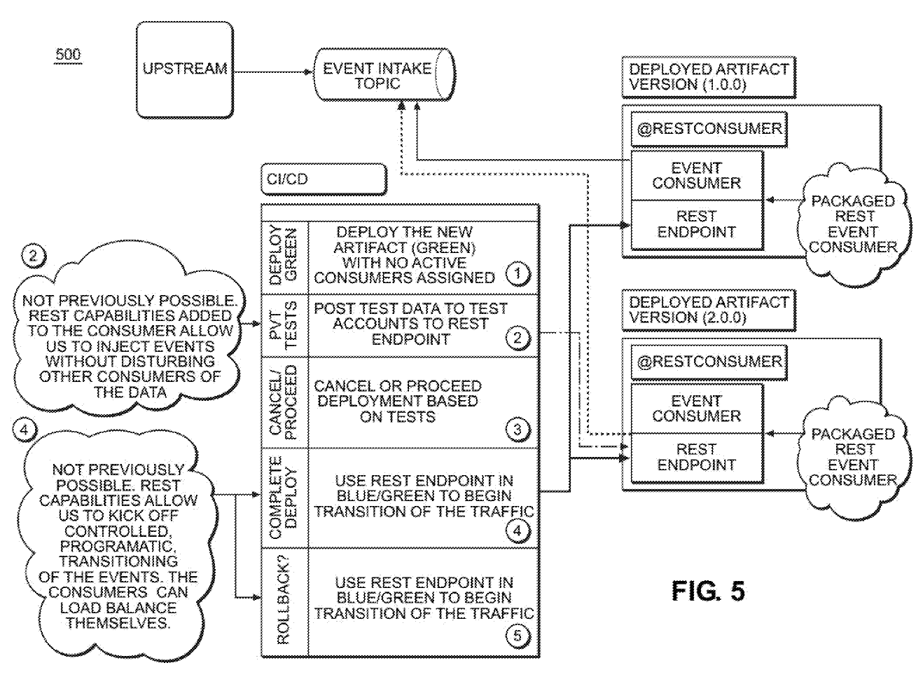

A configuration 500 for applying event consumer application deployment control within a perspective of the network environment of FIG. 2, is depicted as being executed in FIG. 5.

As depicted in FIG. 5, the flow of configuration 500 may be initiated upstream by a module, such as an electronic event producer. The upstream module may be implemented within a client device, which may comprise a Point-of-Sale (PoS) device, for example.

The upstream module may generate network events, such as transactions, which the upstream module may then push to at least one event intake topic of an intermediary, such as an electronic event broker (which may serve as an intermediary between at least one electronic event producer and at least one electronic event consumer that are implemented within at least one electronic event mesh).

As illustrated in configuration 500, at least one electronic event consumer may pull data, such as recent (and/or updated) network event data that pertains to the at least one event intake topic, from the at least one event intake topic of the intermediary (e.g., an electronic event broker of the at least one electronic event mesh). As also illustrated in configuration 500, the at least one electronic event consumer may comprise a deployed artifact version 1.0 and a deployed artifact version 2.0.

Thereby, configuration 500 may implement process 400 to migrate event flows from deployed artifact version 1.0 (which may correspond to the pre-existing event consumer) to deployed artifact version 2.0 (which may correspond to the first set of REST API-based code).

Accordingly, configuration 500 may be utilized to continuously integrate and/or continuously deploy (CI/CD) event consumer applications into the at least one electronic event mesh, for example. As illustrated in configuration 500, a CI/CD process (which may be implemented by a module such as an event consumer application deployment controller) may begin with a first operation that comprises deploying a new artifact, such as deployed artifact version 2.0, which may be labeled as being “green,” which identifies an electronic event consumer that has been deployed but is still being evaluated and/or tested.

As depicted in configuration 500, after the first artifact is deployed, the CI/CD process may continue with a second operation that posts test data (e.g., results of the first operation) associated with test accounts, to a REST endpoint. The instruction to perform the second operation is represented by the arrow drawn from the CI/CD process’ second operation to the REST endpoint of deployed artifact version 2.0. Thereafter, the CI/CD process may proceed to a third operation that either cancels or proceeds with the deployment initiated by the CI/CD process’s first operation.

During a fourth operation, the CI/CD process utilizes the REST endpoints in blue/green to complete deployment by transitioning event flow traffic from deployed artifact version 1.0 to deployed artifact version 2.0. Deployed artifact version 1.0 may be labeled as being “blue,” which identifies an electronic event consumer that has been fully deployed within at least one electronic event mesh.

Additionally, “blue” may also identify an electronic event consumer that is actively processing live electronic network event data of the at least one electronic even mesh. The instruction to perform the fourth operation is represented by the arrow drawn from the CI/CD process’ fourth operation to both deployed artifact version 1.0 and deployed artifact version 2.0.

In the event that any problems or issues arise during or after performing the fourth operation, the CI/CD process may respond by performing a fifth operation that utilizes the REST endpoint in blue/green to rollback the deployment by transitioning the event flow traffic from deployed artifact version 2.0 back to deployed artifact version 1.0.

Accordingly, the herein-disclosed technology may provide a system that implements event consumer application deployment control within at least one electronic event mesh by executing operations (described above) that comprise utilizing REST API architecture to generate an event consumer application that comprises a first set of REST API-based code; deploying the first set of REST API-based code to the at least one electronic event mesh; evaluating at least one performance of the first set of REST API-based code within the at least one electronic event mesh; and utilizing the at least one performance of the first set of REST API-based code to determine whether to cancel or complete deployment of the event consumer application.

Therefore, by employing the herein-disclosed approaches within at least one electronic event mesh, the disclosed subject matter provides a technical improvement to existing technology. Thereby, the approaches disclosed herein provide a solution to needs that exist in conventional AI/ML technologies, such as the need to provide simple and accessible techniques for controlling event-driven endpoint software applications and for keeping such applications up-to-date.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Therefore, applications of the present disclosure are not limited to electronic resource usage efficiency improvements and may be extended to provide a technical improvement to efforts in other technological areas.

Accordingly, although the invention has been described with reference to particular means, materials and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method of implementing event consumer application deployment control within at least one electronic event mesh, the method comprising:
utilizing representational state transfer (REST) application program interface (API) architecture to generate an event consumer application that comprises a first set of code that is based on the REST API architecture (REST API-based code); and
deploying the first set of REST API-based code to the at least one electronic event mesh,
wherein the first set of REST API-based code is configured to subscribe to a first set of event topics of the at least one electronic event mesh.

2. The method of claim 1, further comprising:
evaluating at least one performance of the first set of REST API-based code within the at least one electronic event mesh; and
utilizing the at least one performance of the first set of REST API-based code to determine to one from among cancel deployment of the event consumer application and complete the deployment of the event consumer application.

3. The method of claim 2, wherein the at least one electronic event mesh comprises clusters and utilizes the clusters as primary sources, and primary sinks, of event flow traffic within the at least one electronic event mesh.

4. The method of claim 2, wherein the at least one electronic event mesh comprises a distributed, open-source, publish-subscribe messaging system.

5. The method of claim 2,
wherein when the at least one performance does not meet at least one predetermined criterion, then the at least one performance of the first set of REST API-based code is utilized to determine to cancel the deployment of the event consumer application, and
wherein when the at least one performance meets the at least one predetermined criterion, then the at least one performance of the first set of REST API-based code is utilized to determine to complete the deployment of the event consumer application.

6. The method of claim 2, further comprising:
cancelling the deployment of the event consumer application by utilizing REST API functionalities to recall the first set of REST API-based code from the at least one electronic event mesh.

7. The method of claim 2, wherein the at least one electronic event mesh comprises a pre-existing event consumer application that subscribes to at least one event topic to which the event consumer application is configured to subscribe.

8. The method of claim 7, further comprising completing the deployment of the event consumer application, wherein the completing the deployment comprises:
utilizing REST API functionalities to migrate, at least one event flow of the at least one electronic event mesh, onto the first set of REST API-based code, from the pre-existing event consumer application.

9. The method of claim 8, further comprising:
consuming, by the first set of REST API-based code, the at least one event flow.

10. The method of claim 9, wherein the completing the deployment further comprises:
utilizing the REST API functionalities to recall the pre-existing event consumer application from the at least one electronic event mesh.

11. A system that implements event consumer application deployment control within at least one electronic event mesh, the system comprising:
a processor; and
memory storing instructions that, when executed by the processor, cause the processor to perform operations comprising:
utilizing representational state transfer (REST) application program interface (API) architecture to generate an event consumer application that comprises a first set of code that is based on the REST API architecture (REST API-based code); and
deploying the first set of REST API-based code to the at least one electronic event mesh,
wherein the first set of REST API-based code is configured to subscribe to a first set of event topics of the at least one electronic event mesh.

12. The system of claim 11, wherein when executed, the instructions cause the processor to perform further operations comprising:
evaluating at least one performance of the first set of REST API-based code within the at least one electronic event mesh; and
utilizing the at least one performance of the first set of REST API-based code to determine to one from among cancel deployment of the event consumer application and complete the deployment of the event consumer application.

13. The system of claim 12, wherein when executed by the processor, the instructions cause the at least one electronic event mesh to comprise a pre-existing event consumer application that subscribes to at least one event topic to which the event consumer application is configured to subscribe.

14. The system of claim 13, wherein when executed, the instructions cause the processor to perform further operations comprising:
completing the deployment of the event consumer application, wherein the completing the deployment comprises:
utilizing REST API functionalities to migrate, at least one event flow of the at least one electronic event mesh, onto the first set of REST API-based code, from the pre-existing event consumer application.

15. The system of claim 14, wherein when executed, the instructions cause the processor to perform further operations comprising:
consuming, by the first set of REST API-based code, the at least one event flow.

16. The system of claim 15, wherein when executed by the processor, the instructions cause the completing the deployment to further comprise:
utilizing the REST API functionalities to recall the pre-existing event consumer application from the at least one electronic event mesh.

17. A non-transitory computer-readable medium for implementing event consumer application deployment control within at least one electronic event mesh, the computer-readable medium storing instructions that, when executed by a processor, cause the processor to perform operations comprising:
utilizing representational state transfer (REST) application program interface (API) architecture to generate an event consumer application that comprises a first set of code that is based on the REST API architecture (REST API-based code); and
deploying the first set of REST API-based code to the at least one electronic event mesh,
wherein the first set of REST API-based code is configured to subscribe to a first set of event topics of the at least one electronic event mesh.

18. The computer-readable medium of claim 17, wherein when executed, the instructions cause the processor to perform further operations comprising:
evaluating at least one performance of the first set of REST API-based code within the at least one electronic event mesh; and
utilizing the at least one performance of the first set of REST API-based code to determine to one from among cancel deployment of the event consumer application and complete the deployment of the event consumer application.

19. The computer-readable medium of claim 18,
wherein when the instructions are executed and the at least one performance does not meet at least one predetermined criterion, then the processor utilizes the at least one performance of the first set of REST API-based code to determine to cancel the deployment of the event consumer application, and
wherein when the instructions are executed and the at least one performance meets the at least one predetermined criterion, then the processor utilizes the at least one performance of the first set of REST API-based code to determine to complete the deployment of the event consumer application.

20. The computer-readable medium of claim 18, wherein when executed, the instructions cause the processor to perform further operations comprising:
cancelling the deployment of the event consumer application by utilizing REST API functionalities to recall the first set of REST API-based code from the at least one electronic event mesh.
